(19) United States
(12) Patent Application Publication
(10) Pub. No.: US 2010/0308279 A1
(43) Pub. Date: Dec. 9, 2010

(54) Conductive Silicone and Methods for Preparing Same

(76) Inventors: Chaohui Zhou, Arlington, MA (US); Alan Fischer, Cambridge, MA (US)

Correspondence Address: HYPERION CATALYSIS INTERNATIONAL , INC., LEGAL DEPARMENT, 930 CLOPPER ROAD, GAITHERSBURG, MD, 20878, US

(21) Appl. No.: 11/532,289

(22) Filed: Sep. 15, 2006

Related U.S. Application Data
(60) Provisional application No. 60/717,798, filed on Sep. 16, 2005.

(51) Int. Cl. H01B 1/04

(52) U.S. Cl. 252/511; 977/742

(57) ABSTRACT

Methods of preparing conductive silicones containing carbon nanotubes is provided. The carbon nanotubes may be in individual form or in the form of aggregates having a macromorpology resembling the shape of a cotton candy, bird nest, combed yarn or open net. Preferred multiwalled carbon nanotubes have diameters no greater than 1 micron and preferred single walled carbon nanotubes have diameters less than 5 nm. Carbon nanotubes may be adequately dispersed in a silicone base resin by known conventional equipments and processes to prepare conductive silicone base resins. The conductive silicone base resin is then mixed with a curing agent to form conductive silicone elastomers.

### RELATED APPLICATIONS

This application claims priority to and the benefit of U.S. Provisional Application Ser. No. 60/717,798 filed Sep. 16, 2005, which is hereby incorporated by reference in its entirety.

### BACKGROUND OF THE INVENTION

1. Field of Invention

The invention relates broadly to conductive silicone containing carbon nanotubes. More specifically, the invention relates to silicone composites which contain a low loading of carbon nanotubes and which have electrical conductivity higher than other known conductive thermoset composites for a given carbon nanotube loading level. The conductive silicone may be cured or uncured. The conductive silicone is prepared by, inter alia, dispersing low loading of carbon nanotubes within a silicone base resin.

2. Description of the Related Art

### Conductive Thermosets

Conductive polymers have long been in demand and offer a number of benefits for a variety of applications due to their combined polymeric and conductive properties. The polymeric ingredient in conductive polymers can take the form of thermoplastics or thermosets. General background information on these polymers may be found in numerous publications such as International Plastics Handbook, translated by John Haim and David Hyatt, 3^{rd} edition, Hanser/Gardner Publications (1995) and Mixing and Compounding of Polymers—Theory and Practice, edited by Ica Manas-Zloczower and Zehev Tadmor, Hanser/Gardner Publications (1994), both of which are hereby incorporated by reference. The conductive element of the conductive polymer includes metal powder or carbon black.

Thermoplastics, by their malleable and flexible nature, have proven to be more commercially practical and viable when forming conductive polymers. E.g., U.S. Pat. No. 5,591,382, filed Mar. 30, 1994 to Nahass, et al., hereby incorporated by reference. Thermoplastics are easy to mix with conductive additives by an extrusion process to form a conductive thermoplastic polymer. Furthermore, thermoplastics can be softened upon heating so as to reshape the thermoplastic as necessary. However, thermoplastics lack the strength of thermosets, which crosslink to form stronger polymers. Recent technological developments permit the addition of crosslinking agents to thermoplastics to endow the thermoplastic with greater strength, although such process has its own disadvantages as well (e.g., extra cost, effort, experimentation, etc.)

On the other hand, thermosets, which can have greater strength, are difficult to mix with conductive additives to form a conductive thermoset polymer. Unlike thermoplastics, thermoset polymers are typically formed through a chemical reaction with at least two separate components or precursors. The chemical reaction may include use of catalysts, chemicals, energy, heat, or radiation so as to foster intermolecular bonding such as crosslinking Different thermosets can be formed with different reactions to foster intermolecular bonding. The thermoset bonding/forming process is often referred to as curing. The thermoset components or precursors are usually liquid or malleable prior to curing, and are designed to be molded into their final form, or used as adhesive. Once cured, however, a thermoset polymer is stronger than thermoplastic and is also better suited for high temperature applications since it cannot be easily softened, remelted, or remolded on heating like thermoplastics. Thus, conductive thermoset polymers offer the industry a much desired combination of strength and conductivity.

In particular, there is a growing demand for conductive silicone due to silicone's desirable properties of inertness, thermal stability and resistance to oxidation. However, like other thermosets, silicone generally cannot be melted once it has been cured. Thus, conductive additives must be added and dispersed into the silicone prior to forming the final cured silicone product. This requirement creates a number of limitations in forming conductive silicones, especially conductive silicone having a commercially viable level of electrical conductivity and strength.

As such, there is a need for a new method for forming conductive silicones.

### Silicone

Silicones are synthetic thermoset polymers (e.g., polysiloxane, polyorganosiloxane) which have a wide range of properties that make them useful for a variety of applications such as adhesives, lubricants, water repellents, molding compounds, electrical insulation, surgical implants, automobile engine parts and others applications.

Silicones generally have a structure consisting of alternating silicon and oxygen atoms ( . . . —Si—O—Si—O— . . . ) with various organic radicals such as methyl or benzene group attached to the silicon which prevent the formation of three dimensional network such as silica. The properties of silicone may be influenced by varying the —Si—O— chain lengths, side groups and/or crosslinking of two or more oxygen groups. They can vary in consistency from liquid to gel to rubber to hard plastic, and are available in a variety of forms such as fluid, powder, emulsions, solutions, resins, pastes, elastomer, etc. Generally, silicones are valued for their inertness, thermal stability and resistance to oxidation.

Silicone can be “uncured” or “cured”. Generally, an uncured silicone is referred to as a silicone resin or a silicone base resin. As described in the previous paragraph, the silicone base resin have a structure consisting of alternating silicon and oxygen atoms ( . . . —Si—O—Si—O— . . . ) with various organic radicals attached to the silicon. However, this silicone base resin is “uncured” because it has not yet been crosslinked, for example, via a curing agent. A silicone that has been “cured” is basically a silicone base resin that has been crosslinked, and is often referred to as a silicone elastomer or the final silicone product. The crosslinking endows the silicone elastomer with certain improved properties such as improved strength. Other reactions, such as thru the use of catalyst, heat, energy or radiation may be used to foster intermolecular bonding or crosslinking.

Methods for forming silicone, including the silicone base resin, are well known in the art. For example, one well known method for preparing silicone base resin involves reacting a chlorosilane with water. This produces a hydroxyl intermediate, which condenses to form a polymer-type structure. The basic reaction sequence is represented as:

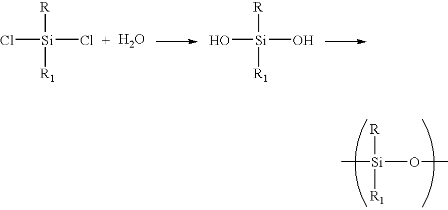

Other precursors to forming a silicone base resin such as alkoxysilanes can be used. Chlorosilanes and other silicone precursors are synthesised using a reaction of elemental silicon with an alkyl halide:

Si+RX→RₙSiX₄₋ₙ (where n=0-4)

Preparation of silicone elastomers requires the formation of high molecular weight (generally greater than 500,000 g/mol). To produce these types of materials requires di-functional precursors, which form linear polymer structures. Mono and tri-functional precursors form terminal structures and branched structures respectively.

Silicone rubbers are usually cured using peroxides such as benzoyl peroxide, 2,4-dichlorobenzoyl peroxide, t-butyl perbenzoate and dicumyl peroxide. Alkyl hydroperoxides and dialkyl peroxides have also been used successfully with vinyl containing silicones.

Hydrosilylation or hydrosilation is an alternative curing method for vinyl containing silicones and utilizes hydrosilane materials and platinum containing compounds for catalysts.

Silicones can be mixed/compounded using mixers or mills, depending on the viscosity of the silicone base resin, which can vary considerably. For example, a silicone gum refers to a viscous silicone base resin.

### Carbon Nanotubes

There are a number of known conductive additives in the art, including carbon black, carbon fibers, carbon fibrils, metallic powder, etc. Carbon fibrils have grown in popularity due to its extremely high conductivity and strength compared to other conductive additives.

Carbon fibrils are commonly referred to as carbon nanotubes. Carbon fibrils are vermicular carbon deposits having diameters less than 1.0μ, preferably less than 0.5μ, and even more preferably less than 0.2μ. They exist in a variety of forms and have been prepared through the catalytic decomposition of various carbon-containing gases at metal surfaces. Such vermicular carbon deposits have been observed almost since the advent of electron microscopy. (Baker and Harris, Chemistry and Physics of Carbon, Walker and Thrower ed., Vol. 14, 1978, p. 83; Rodriguez, N., J. Mater. Research, Vol. 8, p. 3233 (1993)).

In 1976, Endo et al. (see Obelin, A. and Endo, M., J. of Crystal Growth, Vol. 32 (1976), pp. 335-349), hereby incorporated by reference, elucidated the basic mechanism by which such carbon fibrils grow. They were seen to originate from a metal catalyst particle, which, in the presence of a hydrocarbon containing gas, becomes supersaturated in carbon. A cylindrical ordered graphitic core is extruded which immediately, according to Endo et al., becomes coated with an outer layer of pyrolytically deposited graphite. These fibrils with a pyrolytic overcoat typically have diameters in excess of 0.1μ, more typically 0.2 to 0.5μ.

In 1983, Tennent, U.S. Pat. No. 4,663,230, hereby incorporated by reference, describes carbon fibrils that are free of a continuous thermal carbon overcoat and have multiple graphitic outer layers that are substantially parallel to the fibril axis. As such they may be characterized as having their c-axes, the axes which are perpendicular to the tangents of the curved layers of graphite, substantially perpendicular to their cylindrical axes. They generally have diameters no greater than 0.1μ, and length to diameter ratios of at least 5. Desirably they are substantially free of a continuous thermal carbon overcoat, i.e., pyrolytically deposited carbon resulting from thermal cracking of the gas feed used to prepare them. Thus, the Tennent invention provided access to smaller diameter fibrils, typically 35 to 700 Å (0.0035 to 0.070μ) and to an ordered, “as grown” graphitic surface. Fibrillar carbons of less perfect structure, but also without a pyrolytic carbon outer layer have also been grown.

The carbon nanotubes which can be oxidized as taught in this application, are distinguishable from commercially available continuous carbon fibers. In contrast to these fibers which have aspect ratios (L/D) of at least 10⁴ and often 10⁶ or more, carbon fibrils have desirably large, but unavoidably finite, aspect ratios. The diameter of continuous fibers is also far larger than that of fibrils, being always >1.0μ, and typically 5 to 7μ.

Tennent, et al., U.S. Pat. No. 5,171,560, hereby incorporated by reference, describes carbon fibrils free of thermal overcoat and having graphitic layers substantially parallel to the fibril axes such that the projection of said layers on said fibril axes extends for a distance of at least two fibril diameters. Typically, such fibrils are substantially cylindrical, graphitic nanotubes of substantially constant diameter and comprise cylindrical graphitic sheets whose c-axes are substantially perpendicular to their cylindrical axis. They are substantially free of pyrolytically deposited carbon, have a diameter less than 0.1μ, and length to diameter ratio of greater than 5. These fibrils can be oxidized by the methods of the invention.

When the projection of the graphitic layers on the nanotube axis extends for a distance of less than two nanotube diameters, the carbon planes of the graphitic nanotube, in cross section, take on a herring bone appearance. These are termed fishbone fibrils. Geus, U.S. Pat. No. 4,855,091, hereby incorporated by reference, provides a procedure for preparation of fishbone fibrils substantially free of a pyrolytic overcoat. These carbon nanotubes are also useful in the practice of the invention.

Carbon nanotubes of a morphology similar to the catalytically grown fibrils described above have been grown in a high temperature carbon arc (Iijima, Nature 354, 56, 1991). It is now generally accepted (Weaver, Science 265, 1994) that these arc-grown nanofibers have the same morphology as the earlier catalytically grown fibrils of Tennent. Arc grown carbon nanofibers after colloquiolly referred to as “bucky tubes”, are also useful in the invention.

Useful single walled carbon nanotubes and process for making them are disclosed, for example, in “Single-shell carbon nanotubes of 1-nm diameter”, S Iijima and T Ichihashi Nature, vol. 363, p. 603 (1993) and “Cobalt-catalysed growth of carbon nanotubes with single-atomic-layer walls,” D S Bethune, C H Kiang, M S DeVries, G Gorman, R Savoy and R Beyers Nature, vol. 363, p. 605 (1993), both articles of which are hereby incorporated by reference.

Single walled carbon nanotubes are also disclosed in U.S. Pat. No. 6,221,330 to Moy et. al., hereby incorporated by reference. Moy disclosed a process for producing hollow, single-walled carbon nanotubes by catalytic decomposition of one or more gaseous carbon compounds by first forming a gas phase mixture carbon feed stock gas comprising one or more gaseous carbon compounds, each having one to six carbon atoms and only H, O, N, S or Cl as hetero atoms, optionally admixed with hydrogen, and a gas phase metal containing compound which is unstable under reaction conditions for said decomposition, and which forms a metal containing catalyst which acts as a decomposition catalyst under reaction conditions; and then conducting said decomposition reaction under decomposition reaction conditions, thereby producing said nanotubes. The invention relates to a gas phase reaction in which a gas phase metal containing compound is introduced into a reaction mixture also containing a gaseous carbon source. The carbon source is typically a C₁ through C₆ compound having as hetero atoms H, O, N, S or Cl, optionally mixed with hydrogen. Carbon monoxide or carbon monoxide and hydrogen is a preferred carbon feedstock. Increased reaction zone temperatures of approximately 400° C. to 1300° C. and pressures of between about 0 and about 100 p.s.i.g., are believed to cause decomposition of the gas phase metal containing compound to a metal containing catalyst. Decomposition may be to the atomic metal or to a partially decomposed intermediate species. The metal containing catalysts (1) catalyze CO decomposition and (2) catalyze SWNT formation. Thus, the invention also relates to forming SWNT via catalytic decomposition of a carbon compound.

The invention of U.S. Pat. No. 6,221,330 may in some embodiments employ an aerosol technique in which aerosols of metal containing catalysts are introduced into the reaction mixture. An advantage of an aerosol method for producing SWNT is that it will be possible to produce catalyst particles of uniform size and scale such a method for efficient and continuous commercial or industrial production. The previously discussed electric arc discharge and laser deposition methods cannot economically be scaled up for such commercial or industrial production. Examples of metal containing compounds useful in the invention include metal carbonyls, metal acetyl acetonates, and other materials which under decomposition conditions can be introduced as a vapor which decomposes to form an unsupported metal catalyst. Catalytically active metals include Fe, Co, Mn, Ni and Mo. Molybdenum carbonyls and iron carbonyls are the preferred metal containing compounds which can be decomposed under reaction conditions to form vapor phase catalyst. Solid forms of these metal carbonyls may be delivered to a pretreatment zone where they are vaporized, thereby becoming the vapor phase precursor of the catalyst. It was found that two methods may be employed to form SWNT on unsupported catalysts.

The first method is the direct injection of volatile catalyst. The direct injection method is described is U.S. application Ser. No. 08/459,534, incorporated herein by reference. Direct injection of volatile catalyst precursors has been found to result in the formation of SWNT using molybdenum hexacarbonyl [Mo(CO)₆] and dicobalt octacarbonyl [CO₂ (CO)₈] catalysts. Both materials are solids at room temperature, but sublime at ambient or near-ambient temperatures—the molybdenum compound is thermally stable to at least 150°, the cobalt compound sublimes with decomposition “Organic Syntheses via Metal Carbonyls,” Vol. 1, I. Wender and P. Pino, eds., Interscience Publishers, New York, 1968, p. 40).

The second method uses a vaporizer to introduce the metal containing compound (FIG. 12). In one preferred embodiment of the invention, the vaporizer 10, shown at FIG. 12, comprises a quartz thermowell 20 having a seal 24 about 1″ from its bottom to form a second compartment. This compartment has two ¼″ holes 26 which are open and exposed to the reactant gases. The catalyst is placed into this compartment, and then vaporized at any desired temperature using a vaporizer furnace 32. This furnace is controlled using a first thermocouple 22. A metal containing compound, preferably a metal carbonyl, is vaporized at a temperature below its decomposition point, reactant gases CO or CO/H₂ sweep the precursor into the reaction zone 34, which is controlled separately by a reaction zone furnace 38 and second thermocouple 42. Although applicants do not wish to be limited to a particular theory of operability, it is believed that at the reactor temperature, the metal containing compound is decomposed either partially to an intermediate species or completely to metal atoms. These intermediate species and/or metal atoms coalesce to larger aggregate particles which are the actual catalyst. The particle then grows to the correct size to both catalyze the decomposition of CO and promote SWNT growth. In the apparatus of FIG. 11, the catalyst particles and the resultant carbon forms are collected on the quartz wool plug 36. Rate of growth of the particles depends on the concentration of the gas phase metal containing intermediate species. This concentration is determined by the vapor pressure (and therefore the temperature) in the vaporizer. If the concentration is too high, particle growth is too rapid, and structures other than SWNT are grown (e.g., MWNT, amorphous carbon, onions, etc.) All of the contents of U.S. Pat. No. 6,221,330, including the Examples described therein, are hereby incorporated by reference.

U.S. Pat. No. 5,424,054 to Bethune et al., hereby incorporated by reference, describes a process for producing single-walled carbon nanotubes by contacting carbon vapor with cobalt catalyst. The carbon vapor is produced by electric arc heating of solid carbon, which can be amorphous carbon, graphite, activated or decolorizing carbon or mixtures thereof. Other techniques of carbon heating are discussed, for instance laser heating, electron beam heating and RF induction heating.

Smalley (Guo, T., Nikoleev, P., Thess, A., Colbert, D. T., and Smalley, R. E., Chem. Phys. Lett. 243: 1-12 (1995)), hereby incorporated by reference, describes a method of producing single-walled carbon nanotubes wherein graphite rods and a transition metal are simultaneously vaporized by a high-temperature laser.

Smalley (Thess, A., Lee, R., Nikolaev, P., Dai, H., Petit, P., Robert, J., Xu, C., Lee, Y. H., Kim, S. G., Rinzler, A. G., Colbert, D. T., Scuseria, G. E., Tonarek, D., Fischer, J. E., and Smalley, R. E., Science, 273: 483-487 (1996)), hereby incorporated by reference, also describes a process for production of single-walled carbon nanotubes in which a graphite rod containing a small amount of transition metal is laser vaporized in an oven at about 1200° C. Single-wall nanotubes were reported to be produced in yields of more than 70%.

Supported metal catalysts for formation of SWNT are also known. Smalley (Dai., H., Rinzler, A. G., Nikolaev, P., Thess, A., Colbert, D. T., and Smalley, R. E., Chem. Phys. Lett. 260: 471-475 (1996)), hereby incorporated by reference, describes supported Co, Ni and Mo catalysts for growth of both multiwalled nanotubes and single-walled nanotubes from CO, and a proposed mechanism for their formation.

Carbon nanotubes differ physically and chemically from continuous carbon fibers which are commercially available as reinforcement materials, and from other forms of carbon such as standard graphite and carbon black. Standard graphite, because of its structure, can undergo oxidation to almost complete saturation. Moreover, carbon black is amorphous carbon generally in the form of spheroidal particles having a graphene structure, carbon layers around a disordered nucleus. The differences make graphite and carbon black poor predictors of nanotube chemistry.

### Agreates of Carbon Nanotubes

As produced, carbon nanotubes may be in the form of discrete nanotubes, aggregates of nanotubes or both.

Nanotubes produced or prepared as aggregates have various morphologies (as determined by scanning electron microscopy) in which they are randomly entangled with each other to form entangled balls of nanotubes resembling bird nests (“BN”); or as aggregates consisting of bundles of straight to slightly bent or kinked carbon nanotubes having substantially the same relative orientation, and having the appearance of combed yarn (“CY”) e.g., the longitudinal axis of each nanotube (despite individual bends or kinks) extends in the same direction as that of the surrounding nanotubes in the bundles; or, as, aggregates consisting of straight to slightly bent or kinked nanotubes which are loosely entangled with each other to form an “open net” (“ON”) structure. In open net structures the extent of nanotube entanglement is greater than observed in the combed yarn aggregates (in which the individual nanotubes have substantially the same relative orientation) but less than that of bird nest. Other useful aggregate structures include the cotton candy (“CC”) structure, which is similar to the CY structure.

The morphology of the aggregate is controlled by the choice of catalyst support. Spherical supports grow nanotubes in all directions leading to the formation of bird nest aggregates. Combed yarn and open net aggregates are prepared using supports having one or more readily cleavable planar surfaces, e.g., an iron or iron-containing metal catalyst particle deposited on a support material having one or more readily cleavable surfaces and a surface area of at least 1 square meters per gram. Moy et al., U.S. application Ser. No. 08/469,430 entitled “Improved Methods and Catalysts for the Manufacture of Carbon Fibrils”, filed Jun. 6, 1995, hereby incorporated by reference, describes nanotubes prepared as aggregates having various morphologies (as determined by scanning electron microscopy).

Further details regarding the formation of carbon nanotube or nanofiber aggregates may be found in the disclosure of U.S. Pat. No. 5,165,909 to Tennent; U.S. Pat. No. 5,456,897 to Moy et al.; Snyder et al., U.S. patent application Ser. No. 07/149,573, filed Jan. 28, 1988, and PCT Application No. US89/00322, filed Jan. 28, 1989 (“Carbon Fibrils”) WO 89/07163, and Moy et al., U.S. patent application Ser. No. 413,837 filed Sep. 28, 1989 and PCT Application No. US90/05498, filed Sep. 27, 1990 (“Battery”) WO 91/05089, and U.S. application Ser. No. 08/479,864 to Mandeville et al., filed Jun. 7, 1995 and U.S. application Ser. No. 08/284,917, filed Aug. 2, 1994 and U.S. application Ser. No. 08/320,564, filed Oct. 11, 1994 by Moy et al., all of which are assigned to the same assignee as the invention here and are hereby incorporated by reference.

### Oxidation and/or Functionalization of Carbon Nanotubes

Carbon nanotubes or aggregates may be oxidized to enhance certain desirable properties. For example, oxidation can be used to add certain groups onto the surface of the carbon nanotubes or carbon nanotube aggregates, to loosen the entanglement of the carbon nanotube aggregates, to reduce the mass or remove the end caps off the carbon nanotubes, etc.

McCarthy et al., U.S. patent application Ser. No. 08/329,774 filed Oct. 27, 1994, hereby incorporated by reference, describes processes for oxidizing the surface of carbon fibrils that include contacting the fibrils with an oxidizing agent that includes sulfuric acid (H₂SO₄) and potassium chlorate (KClO₃) under reaction conditions (e.g., time, temperature, and pressure) sufficient to oxidize the surface of the fibril. The fibrils oxidized according to the processes of McCarthy, et al. are non-uniformly oxidized, that is, the carbon atoms are substituted with a mixture of carboxyl, aldehyde, ketone, phenolic and other carbonyl groups.

Fibrils have also been oxidized non-uniformly by treatment with nitric acid. International Application PCT/US94/10168 filed on Sep. 9, 1994 as WO95/07316 discloses the formation of oxidized fibrils containing a mixture of functional groups. Hoogenvaad, M. S., et al. (“Metal Catalysts supported on a Novel Carbon Support,” presented at Sixth International Conference on Scientific Basis for the Preparation of Heterogeneous Catalysts, Brussels, Belgium, September 1994) also found it beneficial in the preparation of fibril-supported precious metals to first oxidize the fibril surface with nitric acid. Such pretreatment with acid is a standard step in the preparation of carbon-supported noble metal catalysts, where, given the usual sources of such carbon, it serves as much to clean the surface of undesirable materials as to functionalize it.

In published work, McCarthy and Bening (Polymer Preprints ACS Div. of Polymer Chem. 30 (1)420 (1990)) prepared derivatives of oxidized fibrils in order to demonstrate that the surface comprised a variety of oxidized groups. The compounds they prepared, phenylhydrazones, haloaromaticesters, thallous salts, etc., were selected because of their analytical utility, being, for example, brightly colored, or exhibiting some other strong and easily identified and differentiated signal. These compounds were not isolated and are, unlike the derivatives described herein, of no practical significance.

Fischer et al., U.S. Ser. No. 08/352,400 filed Dec. 8, 1994, Fischer et al., U.S. Ser. No. 08/812,856 filed Mar. 6, 1997, Tennent et al., U.S. Ser. No. 08/856,657 filed May 15, 1997, Tennent, et al., U.S. Ser. No. 08/854,918 filed May 13, 1997, and Tennent et al., U.S. Ser. No. 08/857,383 filed May 15, 1997, all hereby incorporated by reference describe processes for oxidizing the surface of carbon fibrils that include contacting the fibrils with a strong oxidizing agent such as a solution of alkali metal chlorate in a strong acid such as sulfuric acid. Additional useful oxidation treatments for carbon nanotubes include those described in Niu, US Published Application No. 2005/0002850A1, filed May 28, 2004, hereby incorporated by reference.

Additionally, these applications also describe methods of uniformly functionalizing carbon fibrils by sulfonation, electrophilic addition to deoxygenated fibril surfaces or metallation. Sulfonation of the fibrils can be accomplished with sulfuric acid or SO₃ in vapor phase which gives rise to carbon fibrils bearing appreciable amounts of sulfones so much so that the sulfone functionalized fibrils show a significant weight gain.

U.S. Pat. No. 5,346,683 to Green, et al. describes uncapped and thinned carbon nanotubes produced by reaction with a flowing reactant gas capable of reacting selectively with carbon atoms in the capped end region of arc grown nanotubes.

U.S. Pat. No. 5,641,466 to Ebbesen, et al. describes a procedure for purifying a mixture of arc grown arbon nanotubes and impurity carbon materials such as carbon nanoparticles and possibly amorphous carbon by heating the mixture in the presence of an oxidizing agent at a temperature in the range of 600° C. to 1000° C. until the impurity carbon materials are oxidized and dissipated into gas phase.

In a published article Ajayan and Iijima (Nature 361, p. 334-337 (1993)) discuss annealing of carbon nanotubes by heating them with oxygen in the presence of lead which results in opening of the capped tube ends and subsequent filling of the tubes with molten material through capillary action.

In other published work, Haddon and his associates ((Science, 282, 95 (1998) and J. Mater. Res., Vol. 13, No. 9, 2423 (1998)) describe treating single-walled carbon nanotube materials (SWNTM) with dichlorocarbene and Birch reduction conditions in order to incorporate chemical functionalities into SWNTM. Derivatization of SWNT with thionyl chloride and octadecylamine rendered the SWNT soluble in common organic solvents such as chloroform, dichlororomethane, aromatic solvents and CS₂.

Additionally, functionalized nanotubes have been generally discussed in U.S. Ser. No. 08/352,400 filed on Dec. 8, 1994 and in U.S. Ser. No. 08/856,657 filed May 15, 1997, both incorporated herein by reference. In these applications the nanotube surfaces are first oxidized by reaction with strong oxidizing or other environmentally unfriendly chemical agents. The nanotube surfaces may be further modified by reaction with other functional groups. The nanotube surfaces have been modified with a spectrum of functional groups so that the nanotubes could be chemically reacted or physically bonded to chemical groups in a variety of substrates.

Complex structures of nanotubes have been obtained by linking functional groups on the tubes with one another by a range of linker chemistries.

Representative functionalized nanotubes broadly have the formula

[C_{N}H_{L}Rₘ

where n is an integer, L is a number less than 0.1 n, m is a number less than 0.5 n,

each of R is the same and is selected from SO₃H, COOH, NH₂, OH, O, CHO, CN, COCl, halide, COSH, SH, R′, COOR′, SR', SiR'₃, SiOR′_{y}R'_{3-y}, SiO—SiR′₂OR′, R″, Li, AlR′₂, Hg—X, TlZ₂ and Mg—X,

y is an integer equal to or less than 3,

R′ is alkyl, aryl, heteroaryl, cycloalkyl aralkyl or heteroaralkyl,

R″ is fluoroalkyl, fluoroaryl, fluorocycloalkyl, fluoroaralkyl or cycloaryl,

X is halide, and

Z is carboxylate or trifluoroacetate.

The carbon atoms, Cₙ, are surface carbons of the nanofiber.

### Secondary Derivatives of Oxidized Nanotubes

Oxidized carbon nanotubes or carbon nanotube aggregates can be further treated to add secondary functional groups to the surface. In one embodiment, oxidized nanotubes are further treated in a secondary treatment step by further contacting with a reactant suitable to react with moieties of the oxidized nanotubes thereby adding at least another secondary functional group. Secondary derivatives of the oxidized nanotubes are essentially limitless. For example, oxidized nanotubes bearing acidic groups like —COOH are convertible by conventional organic reactions to virtually any desired secondary group, thereby providing a wide range of surface hydrophilicity or hydrophobicity.

The secondary group that can be added by reacting with the moieties of the oxidized nanotubes include but are not limited to alkyl/aralkyl groups having from 1 to 18 carbons, a hydroxyl group having from 1 to 18 carbons, an amine group having from 1 to 18 carbons, alkyl aryl silanes having from 1 to 18 carbons and fluorocarbons having from 1 to 18 carbons.

### SUMMARY OF THE INVENTION

The present invention, which addresses the needs of the prior art, provides conductive silicones containing carbon nanotubes. Also provided is a method of preparing conductive silicones containing carbon nanotubes.

It has been discovered that conductive silicone can be formed with low levels of carbon nanotube loadings and yet achieve a commercially feasible level of electrical conductivity.

It has been further discovered that conductive silicone have higher levels of electrical conductivity for a given carbon nanotube loading compared to other conductive thermosets or polymers at the same carbon nanotube loading.

The carbon nanotubes may be in individual form or in the form of aggregates having a macromorphology resembling the shape of a cotton candy, bird nest, combed yarn or open net. Preferred multiwalled carbon nanotubes have diameters no greater than 1 micron and preferred single walled carbon nanotubes have diameters less than 5 nm.

It has been discovered that carbon nanotubes may be dispersed in a silicone base resin by using conventional mixing equipment or means, such as via a Waring blender, Brabender mixer, etc. to form a conductive silicone base resin. The conductive silicone base resin may contain 0.1 to 30% carbon nanotube or carbon nanotube aggregates by weight.

The conductive silicone base resin may then be cured, such as by reaction with a curing agent, to form a conductive silicone elastomer. The conductive silicone elastomer may also contain 0.1 to 30% carbon nanotubes by weight.

In one embodiment, both the conductive silicone base resin and the conductive silicone elastomer may have a resistivity less than about 10¹¹ ohm-cm, preferably less than 10⁸ ohm-cm, more preferably less than 10⁶ ohm-cm.

In an alternative embodiment, both the conductive silicone base resin and the conductive silicone elastomer may have a resistivity less than about 50 ohm-cm, preferably less than 35 ohm-com, more preferably less than 10 ohm-cm.

Other improvements which the present invention provides over the prior art will be identified as a result of the following description which sets forth a preferred embodiments of the present invention. The description is not in any way intended to limit the scope of the present invention, but rather only to provide a working example of the present preferred embodiments. The scope of the present invention will be pointed out in the appended claims.

### BRIEF DESCRIPTION OF THE DRAWINGS

FIG. 1 displays the results of various tensile measurements as described in Example 3.

FIG. 2 displays the results of certain tensile measurements as described in Example 4.

### DETAILED DESCRIPTION OF THE PREFERRED EMBODIMENTS

### Definitions

The terms “nanotube”, “nanofiber” and “fibril” are used interchangeably to refer to single walled or multiwalled carbon nanotubes. Each refers to an elongated hollow structure preferably having a cross section (e.g., angular fibers having edges) or a diameter (e.g., rounded) less than 1 micron (for multiwalled nanotubes) or less than 5 nm (for single walled nanotubes). The term “nanotube” also includes “buckytubes” and fishbone fibrils.

“Multiwalled nanotubes” as used herein refers to carbon nanotubes which are substantially cylindrical, graphitic nanotubes of substantially constant diameter and comprise a single cylindrical graphitic sheet or layer whose c-axis is substantially perpendicular to the cylindrical axis, such as those described, e.g., in U.S. Pat. No. 5,171,560 to Tennent, et al. The term “multiwalled nanotubes” is meant to be interchangeable with all variations of said term, including but not limited to “multi-wall nanotubes”, “multi-walled nanotubes”, “multiwall nanotubes,” etc.

“Single walled nanotubes” as used herein refers to carbon nanotubes which are substantially cylindrical, graphitic nanotubes of substantially constant diameter and comprise cylindrical graphitic sheets or layers whose c-axes are substantially perpendicular to their cylindrical axis, such as those described, e.g., in U.S. Pat. No. 6,221,330 to Moy, et al. The term “single walled nanotubes” is meant to be interchangeable with all variations of said term, including but not limited to “single-wall nanotubes”, “single-walled nanotubes”, “single wall nanotubes,” etc.

The term “functional group” refers to groups of atoms that give the compound or substance to which they are linked characteristic chemical and physical properties.

A “functionalized” surface refers to a carbon surface on which chemical groups are adsorbed or chemically attached.

“Graphenic” carbon is a form of carbon whose carbon atoms are each linked to three other carbon atoms in an essentially planar layer forming hexagonal fused rings. The layers are platelets only a few rings in diameter or they may be ribbons, many rings long but only a few rings wide.

“Graphenic analogue” refers to a structure which is incorporated in a graphenic surface.

“Graphitic” carbon consists of graphenic layers which are essentially parallel to one another and no more than 3.6 angstroms apart.

The term “aggregate” refers to a dense, microscopic particulate structure comprising entangled carbon nanotubes.

“Silicone” refers to polymers have a structure consisting of alternating silicon and oxygen atoms ( . . . —Si—O—Si—O— . . . ) with various organic radicals attached to the silicon. Silicone includes both uncured or cured silicone (e.g., includes silicone resin, silicone base resin, silicone elastomer, silicone product, etc.)

“Silicone resin” or “silicone base resin” refers to silicone which has not yet been cured (e.g., silicone which has not yet been crosslinked).

“Silicone elastomer” refers to silicone which has been cured (e.g., silicone which has been crosslinked).

“Thermoplastics” refer generally to a class of polymers that typically soften or melt upon heating.

“Thermosets” refer generally to a class of polymers that do not melt upon heating.

The term “viscosity” measures or characterizes the internal resistance to flow exhibited by a material in a fluid like state. Where a material such as a solid needs to be melted in order to permit flow (e.g., because solids cannot flow, they have infinite viscosity), the term “melt viscosity” is often used to measure or characterize the internal resistance of the melted material. Therefore, for purposes of this application and terms used herein, the terms “viscosity” and “melt viscosity” are interchangeable since they both measure or characterize the material or melted material's internal resistance to flow.

### Carbon Nanotubes And Carbon Nanotube Agreates

Any of the carbon nanotubes and carbon nanotube aggregates described in the Description Of The Related Art under the heading “Carbon Nanotubes” or “Aggregates Of Carbon Nanotubes” may be used in practicing the invention, and all of those references therein are hereby incorporated by reference.

The carbon nanotubes preferably have diameters no greater than one micron, more preferably no greater than 0.2 micron. Even more preferred are carbon nanotubes having diameters between 2 and 100 nanometers, inclusive. Most preferred are carbon nanotubes having diameters less than 5 nanometers or between 3.5 and 75 nanometers, inclusive.

The nanotubes are substantially cylindrical, graphitic carbon fibrils of substantially constant diameter and are substantially free of pyrolytically deposited carbon. The nanotubes include those having a length to diameter ratio of greater than 5 with the projection of the graphite layers on the nanotubes extending for a distance of at least two nanotube diameters.

Most preferred multiwalled nanotubes are described in U.S. Pat. No. 5,171,560 to Tennent, et al., incorporated herein by reference. Most preferred single walled nanotubes are described in U.S. Pat. No. 6,221,330 to Moy, et al., incorporated herein by reference. Carbon nanotubes prepared according to U.S. Pat. No. 6,696,387 are also preferred and incorporated by reference.

The aggregates of carbon nanotubes, which are dense, microscopic particulate structure comprising entangled carbon nanotubes and which have a macromorphology that resembles a birds nest, cotton candy, combed yarn, or open net. As disclosed in U.S. Pat. No. 5,110,693 and references therein (all of which are herein incorporated by reference), two or more individual carbon fibrils may form microscopic aggregates of entangled fibrils. The cotton candy aggregate resembles a spindle or rod of entangled fibers with a diameter that may range from 5 nm to 20 nm with a length that may range from 0.1 μm to 1000 μm. The birds nest aggregate of fibrils can be roughly spherical with a diameter that may range from 0.1 μm to 1000 μm. Larger aggregates of each type (CC and/or BN) or mixtures of each can be formed.

The aggregates of carbon nanotubes may be tightly entangled or may be loosely entangled. If desired, the carbon nanotube aggregates may be treated with an oxidizing agent to further loosen the entanglement of the carbon nanotubes without destroying the aggregate structure itself.

### Methods of Preparing

### Conductive Silicones

The present invention includes both conductive silicones as well as methods for preparing conductive silicones. The conductive silicones include conductive silicone base resins as well as conductive silicone elastomers.

To form conductive silicone base resins, carbon nanotubes or carbon nanotube aggregates are dispersed in a silicone base resin by conventional mixing equipments or processes, such as with a Brabender mixer, planetary mixer, Waring blender, milling (e.g., 3 roll mill), sonication, etc. to form a conductive silicone base resin. Carbon nanotube or carbon nanotube aggregates may also be dispersed in a silicone base resin by mixing in a solution, followed by precipation. The silicone base resin may be liquid or solid.

Success in dispersing carbon nanotubes in a silicone base resin may be affected by the viscosity of the silicone base resin. Viscosity is often a function of shear force and includes complex viscosity and the stress strain curve. Viscosity is explained in more detail in Macosko, Christopher W., Rheology: Principles, measurements and applications, Wiley-VCH (1994), hereby incorporated by reference. The viscosity of the silicone base resin may range between 50 cPs (centipoises) to greater than 1,000,000 cPs.

It is preferred that the conductive silicone base resin contain carbon nanotube or carbon nanotube aggregates at loadings between 0.1 and 30%, preferably 0.1 to 10%, more preferably between 0.1 and 2%, most preferably 0.1 to 1%. On the one hand, the bulk resistivity of the conductive silicone base resin may be less than about 10¹¹ ohm-cm, preferably less than 10⁸ ohm-cm, more preferably less than 10⁶ ohm-cm. In an alternative embodiment, the bulk resistivity of an even more conductive silicone base resin may be less than about 50 ohm-cm, preferably less than 35 ohm-cm, more preferably less than 10 ohm-cm.

Once a conductive silicone base resin has been formed, a conductive silicone elastomer can then be formed by reacting the conductive silicone base resin with the corresponding known curing agent or using other known reaction methods to cure the base resin into the final elastomer product. For the example, the base resin may contain enough reactive silicone, catalysts or other reactants such that it will cure without using a separate curing agent. The curing agent, if used, may or may not contain carbon nanotube or carbon nanotube aggregates. The conductive silicone elastomer may have a resistivity less than about 10¹¹ ohm-cm, preferably less than 10⁸ ohm-cm, more preferably less than 10⁶ ohm-cm. In an alternative embodiment, the bulk resistivity of an even more conductive silicone elastomer may be less than about 50 ohm-cm, preferably less than 35 ohm-cm, more preferably less than 10 ohm-cm.

In an alternative embodiment, the conductive silicone elastomer is formed from mixing a silicone base resin with a conductive curing agent. That is, the carbon nanotubes are not added to the silicone base resin as described above, but are instead added to the curing agent using any of the dispersion methods mentioned previously.

The following sections describe various methods of preparing specific conductive silicone base resins and conductive silicone elastomers. Further, one skilled in the art will recognize that these descriptions are not exhaustive and can be modified in accordance with the teachings herein.

### EXAMPLES

The following examples serve to provide further appreciation of the invention but are not meant in any way to restrict the effective scope of the invention.

### Example 1

Various conductive silicone base resin samples were prepared by mixing Hyperion CC fibrils (Hyperion Catalysis International, Inc., Cambridge Mass.) into an uncured silicone gum (RMS 2262, Pawling Rubber Company, Pawling N.Y.) using a Brabender mixing head fitted with roller blades. Silicone gum is a common term for a viscous silicone resin.

Sample A: Measured 54 grams of uncured silicone gum (Pawling RMS 2262 silicone base resin). Measured 6.5 grams of Hyperion CC ground fibrils (i.e., Hyperion CC fibrils that had been previously ground in a hammer mill to remove any lumps). Fed silicone into Brabender mixing head at approximately 50 rpm. Slowly fed in fibril powder over approximately 5 minutes. Increased rpm to 100 for approximately 1 minute. Obtained silicone base resin/carbon nanotube material with 10.7% carbon nanotube loading level after mixing. Compression molded a flat sheet between two pieces of Al foil. Cut out a section and mounted on glass slide. Contacted ends with Ag paint and allowed to dry on top of warm oven (˜5-10 minutes). Measured dimensions and resistance from end to end. As thickness was not uniform, used thickness gauge on stand to measure height of glass slide and then height of sample on slide. The net thickness of the sample was obtained by subtracting the thickness of the glass slide. Measured the thickness at the ends and middle of the length of the strip. For this sample the base height was 0.038″ (0.097 cm) and the heights of the sample (+slide) were 0.066″ (0.17 cm); 0.064″ (0.16 cm); and 0.060″ (0.15 cm), After subtracting the thickness of the slide and taking average used 0.025″ (0.064 cm) as the average thickness to use for resistivity calculations.

Sample B: Measured 57.04 grams of uncured silicone gum (i.e., the Pawling RMS 2262 silicone base resin). Measured 3.09 grams of Hyperion ground CC fibrils. The silicone gum was fed into Brabender mixing head fitted with roller blades which operated at 50 rpm. The CC fibrils were added over the course of 1-2 minutes, and material mixed for 3-4 minutes. This composite had greater strength than material with 10.7% loading level. Repeat procedure as described for Sample A to measure resistivity. Because the rounded tip on the thickness gauge left a dimple (estimated about 0.002″ deep) on the sample, thickness was increased by 0.002″ to compensate

Sample C: Prepared with 6.7% carbon nanotube loading following procedure for Sample B.

Sample D: Prepared with 3.8% carbon nanotube loading following procedure for Sample B.

Sample E: Prepared with 3.07% carbon nanotube loading following procedure for Sample B.

Sample F: Prepared with 3.07% carbon nanotube loading by taking a sample of Sample E and applied additional, higher shear mixing by processing between the first two rolls of a 3-roll mill for approximately 10 minutes. A compression molded, flat specimen was prepared and the resistivity measured as described above for Sample A.

Sample G: Prepared with 2.26% carbon nanotube loading following procedure for Sample B.

The results for Samples A-G are given in the table below:

| | Length | Width | Thickness | | Rho | CC | RMS2262 | CNT loading |
|---|---|---|---|---|---|---|---|---|
| Sample | (in) | (in) | (in) | Ohms | (Ohm-cm) | (g) | (g) | (%) |
| A | 1.41 | 0.275 | 0.025 | 41.5 | 0.51 | 3.09 | 57.04 | 10.7% |
| B | 1.832 | 0.228 | 0.057 | 80.4 | 1.45 | 4.046 | 56.153 | 6.7% |
| C | 2.018 | 0.228 | 0.017 | 1284 | 6.26 | 6.5 | 54 | 5.1% |
| D | 1.678 | 0.201 | 0.052 | 238 | 3.77 | 2.42 | 60.47 | 3.8% |
| E | 1.523 | 0.250 | 0.051 | 279 | 5.9 | 1.914 | 60.353 | 3.07% |
| F | 1.721 | 0.255 | 0.052 | 279 | 5.5 | 1.914 | 60.353 | 3.07% |
| G | 1.594 | 0.250 | 0.048 | 1851 | 35.4 | 1.365 | 59.113 | 2.26% |

### Example 2

Conductive silicone/carbon nanotube composites were also prepared by mild solution mixing followed by precipitation.

2.0 grams of silicone gum was added to 30 mls of THF (tetrahydrofuran) in a polypropylene tube. Stirring via a magnetic stir bar was commenced on a stir plate. After stirring overnight at room temperature the silicone gum/THF mixture is mostly dissolved but is cloudy. Mixture was sonicated briefly with probe sonicator (Branson 450-15 seconds×2 @ 60% power @ 40% duty cycle). Mixture was a bit hazy, but homogeneous and stable after sonication. 60 milligrams of Hyperion CC fibrils was added to mixture and the suspension shaken to distribute. Suspension was then blended on Waring blender for 2×15 seconds on high in 100 ml Waring Blender jar and poured into 100 mls of DI water. Solution was then shaken vigorously for 10-15 seconds to mix and then allowed to sit. A black layer gradually formed at the top of solution. Mixture was filtered onto 0.45 micron PVDF membrane filter. Filter cake was washed 5× with water until no THF odor detected. 4.832 grams of wet filter cake was obtained. The wet filter cake was flattened/pressed between paper towels to remove most of water to result in 2.188 grams weight (Sample 1). A thin strip was cut with a razor blade from the flattened filter cake (dimensions 0.15 cm×0.45 cm×1.7 cm). Resistance was measured from end to end over the longest dimension by touching with the points of a standard DMM (digit multimeter).

The ends of Sample 1 were painted with Ag paint. All materials were placed on hot plate at 60° C.-70° C. to further dry for 3 hours. Net wt=1.854 g. Left on hot plate overnight. Remeasured dimensions and end to end resistance. Cut strip lengthwise to form thinner strip (Sample 2) and measured dimensions and resistance. The following results were obtained:

| | Fibril | | | | | |
|---|---|---|---|---|---|---|
| | loading | Length | Width | Thickness | | Rho |
| Sample | (%) | (cm) | (cm) | (cm) | Ohms | (Ohm-cm) |
| 1 | 3% | 1.68 | 0.45 | 0.15 | 103 | 4.1 |
| 2 | 3% | 1.77 | 0.24 | 0.17 | 194 | 4.5 |

### Example 3

Three silicone samples were prepared with ammonia plasma treated CC fibrils, plain CC fibrils and no fibrils. CC fibrils (Hyperion Catalysis International, Inc., Cambridge, Mass.) were blended into the base resin of a two component silicone elastomer (Sylgard 184) using a 3 roll mill. CC fibrils were also blended into the corresponding curing agent using a probe sonicator instead of the 3 roll mill since the viscosity of the curing agent is lower than that of the uncured base silicone resin. The two mixtures were then blended together in a 10:1 by weight ratio using the 3 roll mill.

Ammonia plasma treated CC fibrils: 0.4 g plain CC were treated in ammonia plasma using a Harrick plasma cleaner for 15 minutes. The chamber door had been fitted with a rotary pass-through so that the sample holder in the chamber could be rotated in the vacuum chamber to agitate the powder bed during treatment. A constant rotation was used during the plasma treatment. The plasma chamber was pumped down to 10 millitorr before anhydrous ammonia gas was introduced. The chamber pressure was maintained at 100 millitorr with ammonia gas during the treatment at the high power setting of the Harrick unit. The treated fibrils were mixed with silicone elastomer base and curing agent separately at 0.5 wt % loading. The fibril/elastomer base mixture went through 3 passes on the 3-roll mill, while the fibril/curing agent mixture was sonicated for 2-3 mins. The two parts were then mixed and went through 3-roll mill for 2 passes. The mixture was degassed in vacuum for 40 minutes before being coated or pressed into a film.

Plain CC fibrils: Another sample was prepared with untreated, plain CC fibrils using the mixing/blending procedure described for ammonia plasma treated fibrils.

Control: A comparative silicone sample with no carbon nanotubes was also prepared.

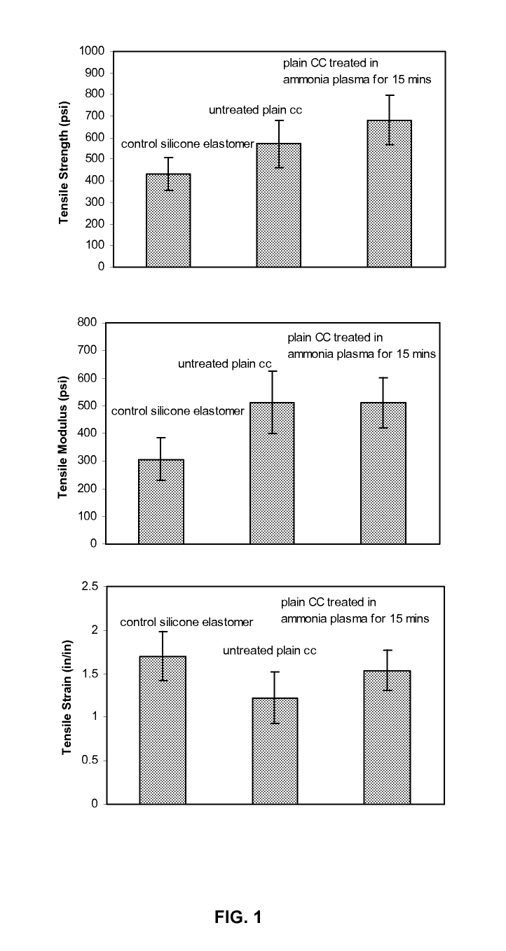

Specimens were cut from the smooth bubble-free films and tested after curing into silicone elastomer for 5 days. For each sample, 10-15 specimens were tested. Tests were measured on an MTS Alliance RT/30. The tensile strength results are shown in FIG. 1.

### Example 4

Several more batches of silicone/carbon nanotube composites were made using the same procedure as in Example 3.

Ammonia plasma treated fibrils: Plain CC fibrils were treated in ammonia plasma for different time periods (10 minutes and 15 minutes) following the procedure in Example 3.

The various silicone/carbon nanotube composites where prepared by mixing the respective treated or untreated fibrils with silicone elastomer (Sylgard 184) base resin and curing agent separately at 0.5 wt % loading. The fibril/elastomer base mixture was processed through the 3-roll mill for 3 passes while the fibril/curing agent mixture was sonicated for 2-3 minutes using a probe sonicator. The two mixtures were then mixed and processed through a 3-roll mill again. Resistivity was measured as described in Example 3. The results are presented below:

| | Fibril | | No. passes through mill | |
|---|---|---|---|---|
| | loading | NH₃ Plasma | after combining | Resistivity |
| Sample | (wt %) | (mins) | mixtures | (Ohm-cm) |
| A0 | 0 | — | — | — |
| A1 | 0.5 | 0 | 2 | N |
| A2 | 0.5 | 20 | 2 | 10⁵~10⁷ |
| A3 | 0.5 | 30 | 2 | N |
| B0 | 0 | — | — | — |
| B1 | 0.5 | 15 | 3 | 5 × 10³ |
| C0 | 0 | — | 5 | — |
| C1 | 0.5 | 0 | 5 | 5.9 × 10² |
| C2 | 0.5 | 15 | 5 | 2.5 × 10³ |
| C3 | 0.5 | 10 | 5 | 5.5 × 10² |

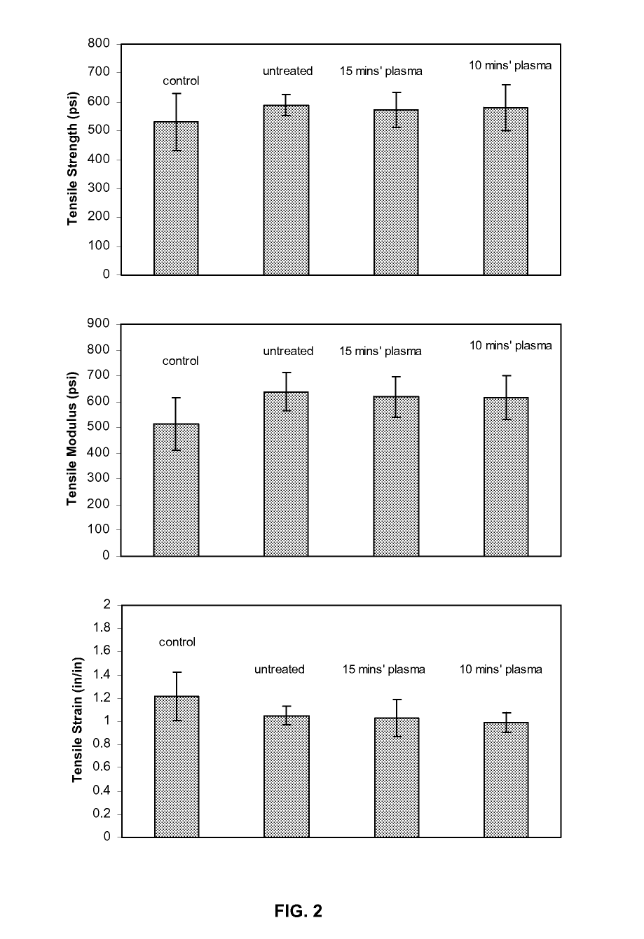

Selected results also presented in FIG. 2.

### Example 5

A silicone base resin/carbon nanotube sample from Example 1 is mixed with a curing agent by blending on a 2 roll mill. For a vinyl methyl silicone gum, a di-t-dutylperoxide catalyst can be used. The catalyst is prepared as a concentrate in silicone resin and a preweighed amount of the concentrate is added to the Example 1 sample on the 2 roll mill. After a few minutes on the mill, a blade is used to retrieve the material from the mill after which it is added back to the mill to mix again. This procedure is repeated 3 times. After the third pass the material is recovered from the 2 roll mill, sandwiched between two metal sheets and placed in a heated oven to cure. The curing temperature is determined by the nature of the peroxide catalyst used and the recommendations of the resin manufacturer. After curing, the metal sheets are removed to yield a cured sheet of conductive, silicone elastomer. Because only a small amount of catalyst is used, the concentration of the conductive fibril additive is not reduced significantly from the concentration of the original Example 1 sample. (i.e., the uncured silicone/carbon nanotube gum).

### Example 6

Conductive silicone composites are prepared by mixing silicone base resin with a curing agent/carbon nanotube mixture.

CC fibrils are blended into the curing agent for Sylgard 184 silicone base resin at a concentration of 5% by weight. The fibrils are blended into the Sylgard 184 curing agent in a plastic cup using a spatula until all the fibrils are wetted. The mixture is then further blended by two passes through a 3 roll mill. The curing agent/carbon nanotube mixture is recovered from the mill and weighed. Sylgard 184 silicone base resin equal to 9.5 times the weight of the curing agent/carbon nanotube mixture is weighed out and mixed in a beaker with the curing agent/carbon nanotube mixture using a spatula. The mixture is then sent through 3 passes on the 3 roll mill. The material is collected, sandwiched between two metal sheets and allowed to cure for 48 hours at room temperature. After curing, the metal sheets are removed yielding a sheet of cured, conductive, silicone elastomer with a carbon nanotube loading of 0.5%.

### Example 7

Silicone composite materials were prepared by dispersing Hyperion carbon nanotubes in Sylgard 184 silicone elastomer resin using a Buhler K-8 conical bead mill.

Hyperion carbon nanotubes were dispersed in Dow Corning Sylgard® 184 silicone elastomer base using a Buhler K-8 conical bead mill. A masterbatch was prepared in a Waring blender. 80 grams of Hyperion carbon nanotubes were put in a beaker. 160 grams of Sylgard 184 base resin was added to the nanotubes in the beaker and were blended with stirring. This was placed in a 2 L Waring blender jar and blended to form a uniform, wetted powder. An additional 80 grams of Sylgard 184 silicone resin were added and blended in the Waring blender. Thus a 25% masterbatch was prepared. It is a loose wetted powder.

3.92 kg of Dow Corning Sylgard® 184 silicone elastomer base was added to the feed hopper of the Buhler K-8 bead mill. 80 grams of the 25% masterbatch was added with stirring with a rubber spatula to obtain a 0.5% nanotube concentration in the mixture. When blended with the spatula the feed hopper was fitted with an overhead stirrer which kept the material uniform while feeding to the bead mill. The feed from the hopper was fed to the inlet of the Buhler K-8 with a gear pump.

The K-8 was loaded with 600 mls of 1.6 mm stainless steel beads. The separation gap was at 0.4 mm. Rotor speed was set to ˜1000 rpm. Pump flow was set at 10% leading to a throughput of ˜5 kg/hr. Power load was ˜3 kW. The product materials was uniform with a glossy black surface. The viscosity was high and the material was barely self-leveling. A small drop of the product was placed between two microscope slides and squeezed to form a semi-transparent film. Pieces of commercial, household aluminum foil were used as spacers to control film thickness. Examination under a microscope showed that the material was uniform with a near absence of agglomerates.

### Example 8

A composite silicone resin with a 1% carbon nanotube loading was prepared in the Buhler K-8 conical bead mill using the method of Example 7. A 1% blend was mixed in the feed hopper starting with the 25% masterbatch. Rotor speed was set to 1150 rpm. Pump speed was set to 5%. Power consumed was recorded as ˜4 kW and throughput was measured as 3 kg/hr. The product material was a very viscous paste-like consistency that was not self-leveling. A small drop of the product was placed between two microscope slides and squeezed to form a semi-transparent film. Pieces of commercial, household aluminum foil were used as spacers to control film thickness. Examination under a microscope showed that the material was uniform with a near absence of agglomerates.

### Example 9

A 0.6% sample was prepared by the method described in Example 7 except that the output of the K-8 bead mill was directed back into the feed hopper so that the material could recirculate. A smaller, 2 kg charge was used in the feed hopper and the throughput of the mill was 5.0 kg/hour allowing for multiple passes through the mill during the 1 hour that the material was recirculated. A small drop of the product was placed between two microscope slides and squeezed to form a semi-transparent film. Pieces of commercial, household aluminum foil were used as spacers to control film thickness. Examination under a microscope showed that the material was uniform with a near absence of agglomerates.

The terms and expressions which have been employed are used as terms of description and not of limitations, and there is no intention in the use of such terms or expressions of excluding any equivalents of the features shown and described as portions thereof, it being recognized that various modifications are possible within the scope of the invention.

1. A method of preparing a conductive silicone base resin consisting of:
dispersing carbon nanotubes in a silicone base resin,
wherein said carbon nanotubes have a diameter less than 1 micron and include single walled carbon nanotubes having diameters less than 5 nanometers,
the concentration of said carbon nanotubes being in the range of 0.1 to 3.8% by weight, and
the conductive silicone base resin having a resistivity of less than 50 ohm-cm.

2. (canceled)

3. The method of preparing the conductive silicone base resin of claim 1, wherein said carbon nanotubes are in the form of aggregates of carbon nanotubes, said aggregates having a macromorphology resembling birds nest, cotton candy, combed yarn or open net.

4. A method of preparing a conductive silicone elastomer comprising:
preparing a conductive silicone base resin by the method of claim 1,
reacting said conductive silicone base resin with a curing agent to form a conductive silicone elastomer.

5. A conductive silicone base resin prepared by the method of claim 1, the conductive silicone base resin consisting of:
a silicone base resin, and
carbon nanotubes having diameters less than 1 micron,
wherein said carbon nanotubes are present at a concentration of 0.1 to 3.8% by weight and said conductive silicone base resin has a resistivity less than 50 ohm-cm.

6. (canceled)

7. The conductive silicone base resin of claim 5, wherein said carbon nanotubes are in the form of aggregates of carbon nanotubes, said aggregates having a macromorphology resembling birds nest, cotton candy, combed yarn or open net.

8. A conductive silicone elastomer, comprising:
the conductive silicone base resin of claim 5, and
a curing agent.

9. A method of preparing a conductive silicone elastomer comprising:
dispersing carbon nanotubes in a silicone base resin, wherein:
the carbon nanotubes have a diameter less than 1 micron and are present at a concentration of 0.1 to 30% by weight; and
the silicone base resin comprising carbon nanotubes has a resistivity of less than 10¹¹ ohm-cm; and
reacting the silicone base resin comprising carbon nanotubes without a separate curing agent to form a conductive silicone elastomer.

10. A conductive silicone elastomer prepared by the method of claim 9.

11. A method of preparing a conductive silicone elastomer comprising:
dispersing carbon nanotubes in a silicone base resin, wherein:
the carbon nanotubes have a diameter less than 1 micron and are present at a concentration of 0.1 to 3.8% by weight; and
the silicone base resin comprising carbon nanotubes has a resistivity of less than 50 ohm-cm; and
reacting said conductive silicone base resin with a curing agent to form a conductive silicone elastomer.

12. A conductive silicone elastomer prepared by the method of claim 11.

13. The method of claim 11, wherein the carbon nanotubes are present at a concentration of 0.1 to 2% by weight.
